(19) United States
(12) Patent Application Publication
(10) Pub. No.: US 2010/0060862 A1
(43) Pub. Date: Mar. 11, 2010

(54) VIDEO PROJECTOR

(75) Inventor: Kazuya Minami, Hirakata-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 12/552,712

(22) Filed: Sep. 2, 2009

(30) Foreign Application Priority Data
Sep. 5, 2008 (JP) 2008-228458

(51) Int. Cl. G03B 21/16

(52) U.S. Cl. 353/61

(57) ABSTRACT

A video projector including an light emitting tube which emits light to display an image, a reflector encompassing the light emitting tube and defining a reflection chamber, a cooling fan which generates a cooling airflow for cooling the light emitting tube, and a duct defining a cooling airflow passage, which includes a bent portion, arranged between the cooling fan and the light emitting tube. An airflow redirection member adjusts the direction of the cooling airflow in the cooling airflow passage. The airflow redirection member includes an open portion, which allows passage of the cooling airflow from the duct into the reflection chamber of the reflector, and a closed portion, which forms stagnation of the cooling airflow in the duct.

### CROSS-REFERENCE TO RELATED APPLICATIONS

This application is based upon and claims the benefit of priority from prior Japanese Patent Application No. 2008-228458, filed on Sep. 5, 2008, the entire contents of which are incorporated herein by reference.

### BACKGROUND OF THE INVENTION

The present invention relates to a video projector such as a liquid crystal display (LCD) projector.

A typical video projector such as an LCD projector uses a lamp including a light emitting tube, which emits light to show an image, and a reflector, which encompasses the light emitting tube. The video projector projects the light emitted from the lamp toward the front onto a projection surface, such as a screen, to show an image.

Excessive temperature rise of the light emitting tube is one factor that shortens the lifespan of the light emitting tube. Japanese Laid-Open Patent Publication No. 2007-298891 describes a cooling structure for a video projector. The cooling structure includes a cooling fan for generating a cooling airflow, a duct for circulating the cooling airflow, and a cooling airflow adjustment member for directing the cooling airflow towards the light emitting tube.

### SUMMARY OF THE INVENTION

There is a demand for compact LCD projectors. To meet this demand, the locations in which a cooling fan can be installed are limited. As a result, a cooling airflow passage, which is defined by the duct, is bent at many locations. Bent portions in the cooling airflow passage produce swirling flow components in the cooling airflow that flows into a reflection chamber of the reflector. Due to such a swirling flow component, the cooling airflow adjustment member of Japanese Laid-Open Patent Publication No. 2007-298891 cannot sufficiently direct the cooling airflow toward the light emitting tube.

To preventing swirling flow components from being produced in the cooling airflow, the shape of the duct may be changed. However, limitations such as device dimensions affect duct design.

The present invention provides a video projector that prevents a cooling airflow from being deflected from the light emitting tube due to the shape of the cooling airflow passage, while improving the degree of design freedom for the duct that defines the cooling airflow passage.

One aspect of the present invention is a video projector including an light emitting tube which emits light to display an image. A reflector encompasses the light emitting tube and defines a reflection chamber. A cooling fan generates a cooling airflow for cooling the light emitting tube. A duct defining a cooling airflow passage, which includes a bent portion, is arranged between the cooling fan and the light emitting tube. An airflow redirection member adjusts the direction of the cooling airflow in the cooling airflow passage. The airflow redirection member includes an open portion, which allows passage of the cooling airflow from the duct into the reflection chamber of the reflector, and a closed portion, which forms stagnation of the cooling airflow in the duct.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a preferred embodiment of an LCD projector;

FIG. 2 is a schematic diagram showing the layout of optical components in the LCD projector of FIG. 1;

FIG. 3 is a perspective view showing the internal structure of the LCD projector of FIG. 1;

FIG. 4 is a perspective view showing a cross-section taken along line A-A in FIG. 3;

FIG. 5 is a partial exploded perspective view of the LCD projector of FIG. 1 showing a lamp, a lamp holder, and an airflow redirection member attached to the lamp holder;

FIGS. 6(a) and 6(b) are perspective views showing the airflow redirection member of FIG. 5;

FIGS. 7(a), 7(b), 8(a), and 8(b) are exploded perspective views showing the airflow redirection member of FIG. 5;

FIG. 9 shows the airflow redirection member located diagonally frontward from the light emitting tube;

FIG. 10 is a perspective view showing a cross-section of the lamp of FIG. 9 in a state in which the airflow redirection member forms an air reservoir (stagnation) in the cooling airflow;

FIG. 11 is a schematic view of FIG. 10 but does not show the airflow redirection member;

FIG. 12 is a front view showing the lamp and the airflow redirection member;

FIG. 13(a) is a cross-sectional view taken along line B-B in FIG. 12; and

FIG. 13(b) is a cross-sectional view taken along line C-C in FIG. 12.

### DETAILED DESCRIPTION OF THE PREFERRED EMBODIMENTS

A preferred embodiment of a video projector according to the present invention will now be discussed with reference to the drawings. The video projector projects light, which is emitted from a lamp, toward the front onto a projection surface such as a screen.

One example of a video projector is an LCD projector 1 (see FIG. 1), which uses liquid crystal for a light bulb.

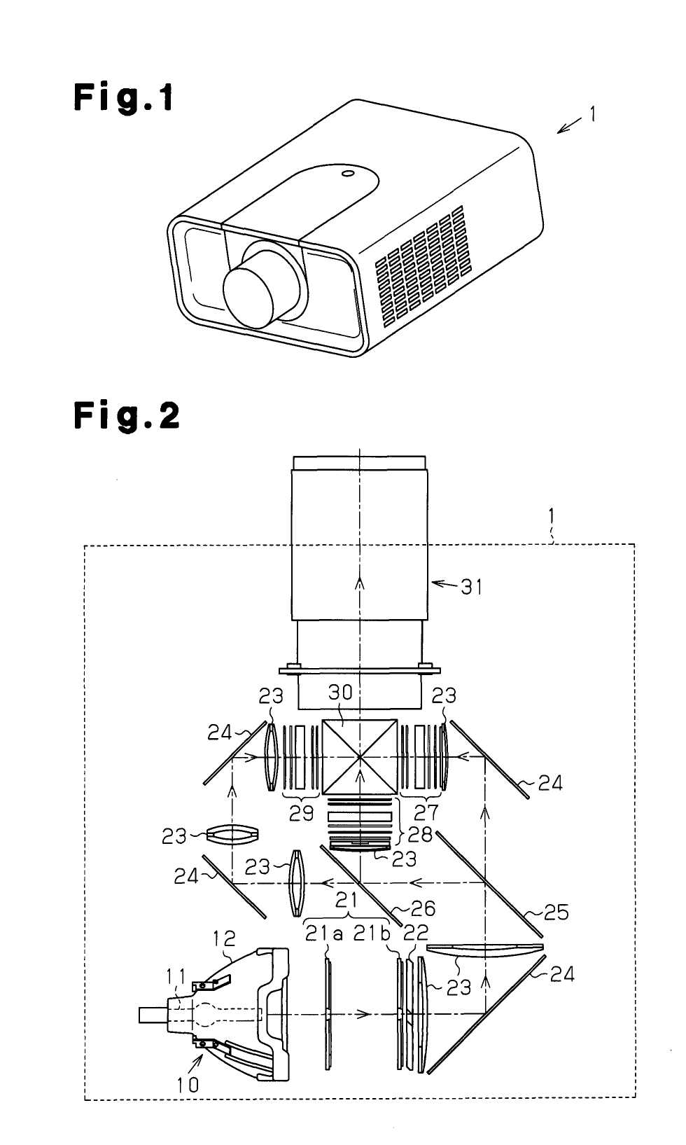

As shown in FIG. 2, the LCD projector 1 includes a lamp 10, an integrator lens 21, a polarization conversion element 22, condenser lenses 23, mirrors 24, dichroic mirrors 25 and 26, liquid crystal light bulbs 27, 28, and 29, a dichroic prism 30, and a projection lens 31. These optical components will now be described in detail.

One example of the lamp 10 that emits light is a super high pressure mercury lamp, in which a mixture of mercury and halogen gas or a mixture of mercury and halogenide is encapsulated in an light emitting tube 11 formed from quarts glass. A reflector 12 encompasses the light emitting tube 11 so that light is emitted in only a predetermined direction from the lamp 10.

The integrator lens 21 includes two fly-eye lenses 21a and 21b, which are formed from heat resistant glass. The illuminace of the light emitted from the lamp 10 is equally distributed when passing through the integrator lens 21.

The polarization conversion element 22 includes a polarization separation film and a phase difference plate, and converts the light emitted from the lamp 10 to a linear polarized light. Specifically, the polarization conversion element 22 includes a polarization separation film, which separates light into P polarized light and S polarized light, and a phase difference plate, which shifts the phase of either the P polarized light or the S polarized light. The light entering the liquid crystal light bulbs 27 to 29 is converted into a linear polarized light by the combination of the polarization separation film and the phase difference plate.

The condenser lenses 23 each gather the light emitted from the lamp 10 in accordance with the size of the optical component through which the light passes. The mirrors 24 reflect the light emitted from the lamp 10 to guide the light to the liquid crystal light bulbs 27 to 29, the dichroic prism 30, and the projection lens 31 by.

The dichroic mirror 25 selectively reflects red light and green light. The dichroic mirror 26 selectively reflects green light. Accordingly, the dichroic mirror 25 separates blue light from the white light emitted from the lamp 10, and the dichroic mirror 26 further separates red light and green light each other.

Each of the liquid crystal light bulbs 27 to 29 includes a liquid crystal panel, which has liquid crystal held between transparent electrodes, polarization plates, which are arranged at the entrance side and exit side of the liquid crystal panel, and an optical compensation plate, which compensates for the birefringence of the light transmitted through the liquid crystal panel.

Three images, each corresponding to one of the three primary colors of light, are generated when light passes through the liquid crystal light bulbs 27 to 29. Specifically, a blue image is generated when the blue light separated from the white light passes through the liquid crystal light bulb 27. A green image is generated when green light passes through the liquid crystal light bulb 28. A red image is generated when red light passes through the liquid crystal light bulb 29.

The dichroic prism 30 generates a full-color image by combining the three images generated by the liquid crystal light bulbs 27 to 29. Specifically, from the lights that pass through the liquid crystal light bulbs 27 to 29, the dichroic prism 30 reflects and emits blue light and red light toward the front of the LCD projector 1. Further, the dichroic prism 30 transmits and emits green light toward the front of the projector 1.

The projection lens 31 includes a plurality of lenses. The light emitted from the dichroic prism 30 enters the projection lens 31. Then, the projection lens 31 emits the light towards the front of the LCD projector 1 to project and display a full-color image.

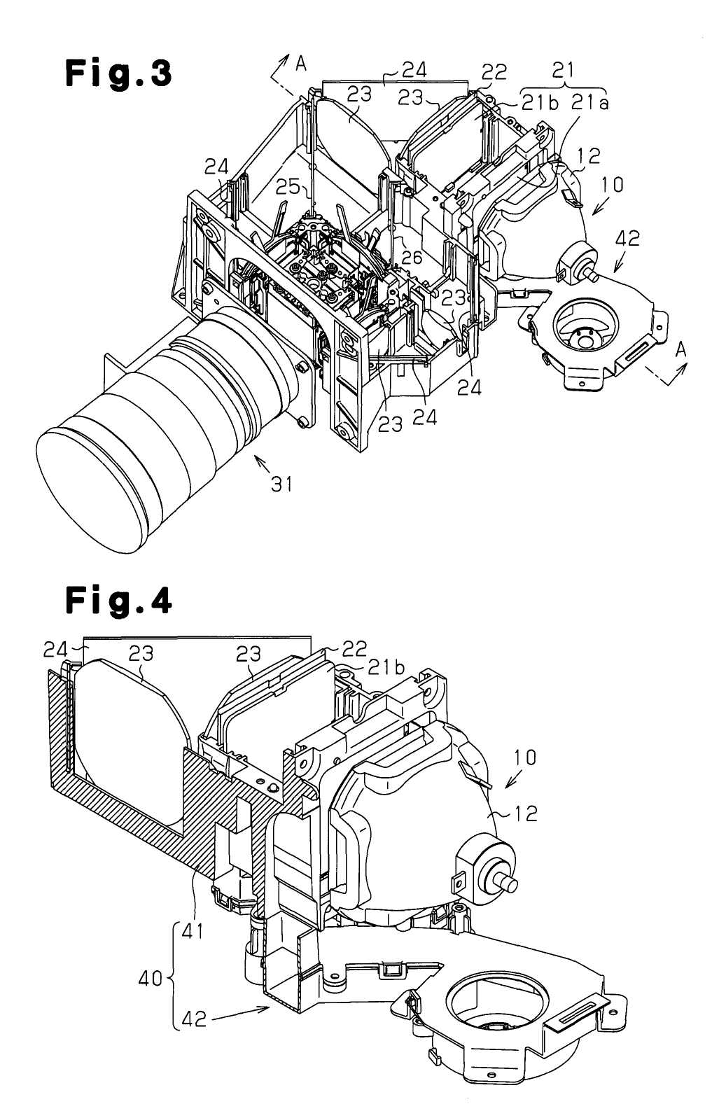

The optical components described above are attached to and supported by a support member in the LCD projector 1. Specifically, referring to FIG. 3, the integrator lens 21, the polarization conversion element 22, the condenser lens 23, the mirror 24, and the dichroic mirrors 25 and 26 are attached to a resin support member 41.

The LCD projector 1 includes a cooling fan (not shown), which generates a current of cooling air or a cooling airflow to cool the light emitting tube, and a duct 40, which circulates the cooling airflow. In the example shown in FIG. 4, the duct 40 is formed by a duct 42, which leads to the cooling fan, and part of the support member 41, which has a hollow portion that is in communication with a hollow portion of the duct 42.

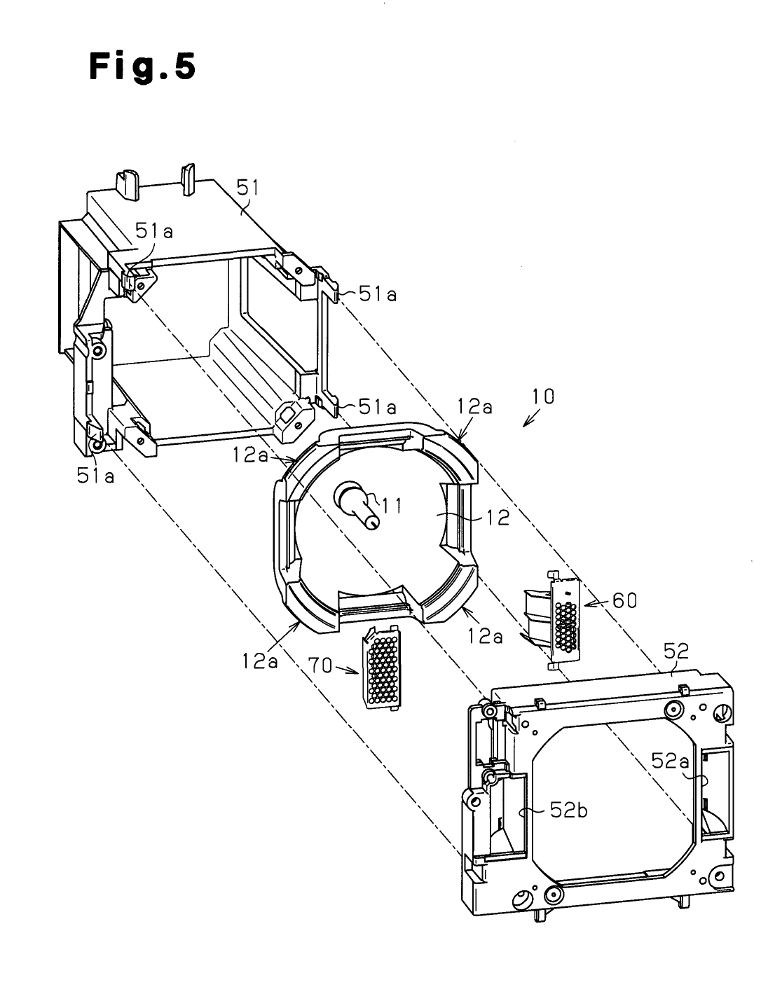

A structure for holding the lamp 10 will now be described with reference to FIG. 5.

The lamp 10 is accommodated in a lamp holder 51. A lamp cover 52 is attached to the lamp holder 51 in a state accommodating the lamp 10. The reflector 12 has an open edge 12a held between the lamp holder 51 and the lamp cover 52. In this manner, the lamp 10 is held. The lamp holder 51 is a container having an open end, which is for accommodating the lamp 10, and four hooks 51a, which are formed on the open end. The lamp cover 52 is a square frame formed to be engageable with the four hooks 51a. The lamp cover 52 is fixed to the lamp holder 51 by engaging the hooks 51a of the lamp holder 51 with the lamp cover 52.

The lamp cover 52 includes a ventilation hole 52a (inlet) and a ventilation hole 52b (outlet). Gas from the cooling fan (hereinafter referred to as cooling airflow) flows through the ventilation hole 52a into the reflection chamber of the reflector 12. The gas in the reflection chamber is then discharged out of the ventilation hole 52b (outlet) toward an exhaust heat fan (not shown). An airflow redirection member 60 is arranged on the ventilation hole 52a to adjust the direction of the cooling airflow that flows into the reflection chamber of the reflector 12. Further, an airflow redirection member 70 is arranged on the ventilation hole 52b to adjust the direction of the gas discharged out of the reflection chamber of the reflector 12. The airflow redirection members 60 and 70 may respectively be referred to as an inlet airflow redirection member and an outlet airflow redirection member.

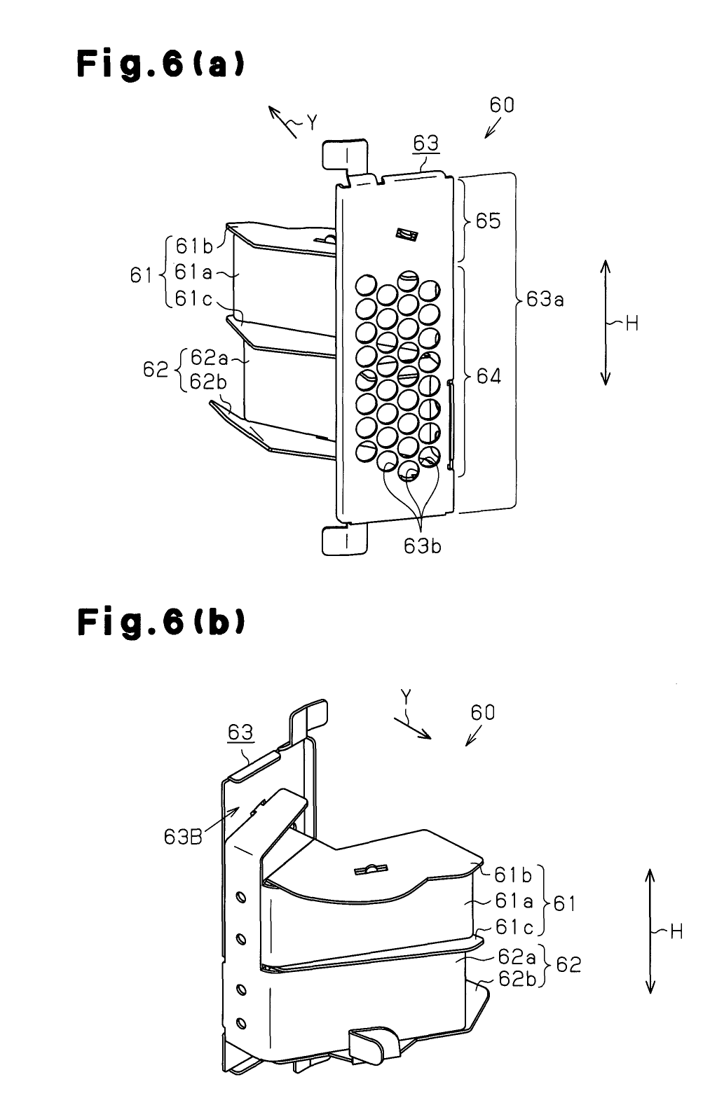

Referring to FIGS. 6 to 8, the airflow redirection member 60 includes airflow redirection plates 61 and 62 and a support 63, to which the airflow redirection plates 61 and 62 are attached. The airflow redirection plates 61 and 62 and the support 63 are formed by pressed metal plates.

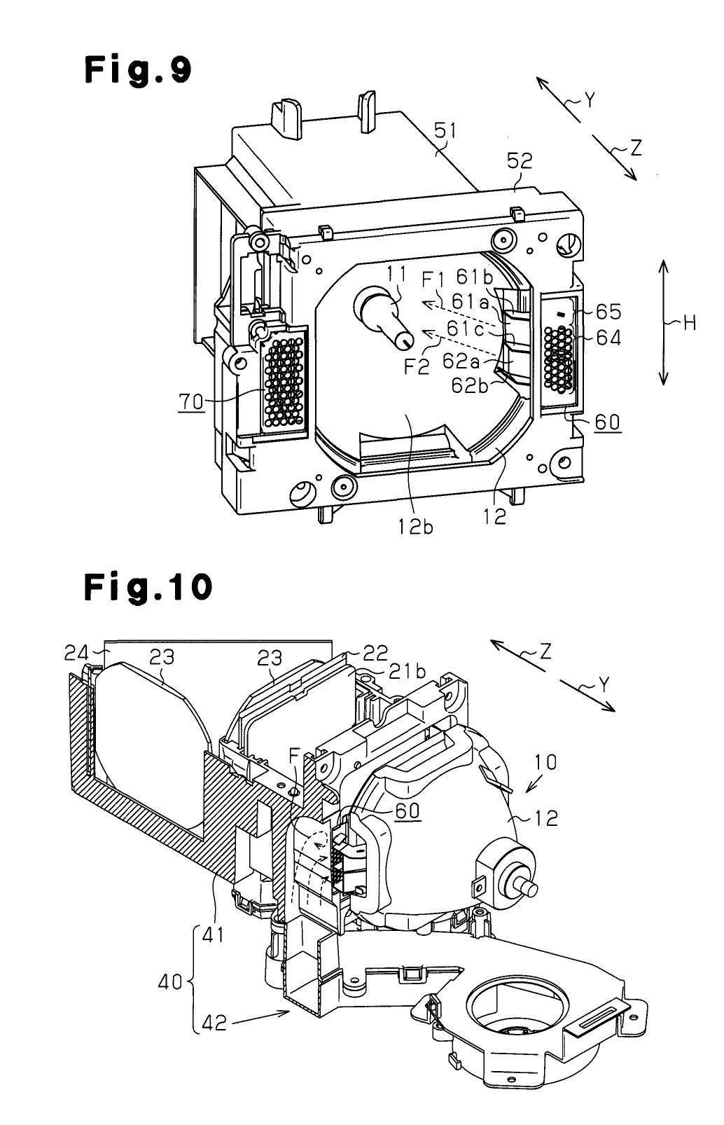

Referring to FIG. 9, the airflow redirection member 60, which is arranged diagonally toward the front from the light emitting tube 11, adjusts the direction of the cooling airflow so that the cooling airflow flows towards the light emitting tube 11 from a gap between a cover glass (not shown), which covers the front of the lamp 10, and the reflector 12. The “front” of the light emitting tube 11 refers to the direction in which the lamp 10 emits light (indicated by arrow Z in the drawings). The longitudinal direction H of the support 63 is orthogonal to the front direction Z.

The airflow redirection plate 61 includes a plate portion 61a and side wall portions 61b and 61c. The plate portion 61a extends from a rear side 63B of the support 63 in a rear direction Y (direction opposite to the front direction Z) with its plane being parallel to the longitudinal direction H of the support 63. The side wall portions 61b and 61c each have a plane that extends substantially perpendicular to the longitudinal direction H of the support 63. The side wall portions 61b and 61c are located at the two sides of the plate portion 61a in the longitudinal direction H of the support 63. The airflow redirection plate 61 is spot-welded and fixed to the airflow redirection plate 62.

The airflow redirection plate 62 includes a plate portion 62a and a side wall portion 62b. The plate portion 62a extends from the rear side 63B of the support 63 toward the rear direction Y with its plane being parallel to the longitudinal direction H of the support 63. The side wall portion 62b has a plane that extends substantially perpendicular to the longitudinal direction H of the support 63. The side wall portion 62b is located at the side of the plate portion 62a farthest from the plate portion 61a in the longitudinal direction H of the support 63. The airflow redirection plate 62 is spot-welded and fixed to the support 63.

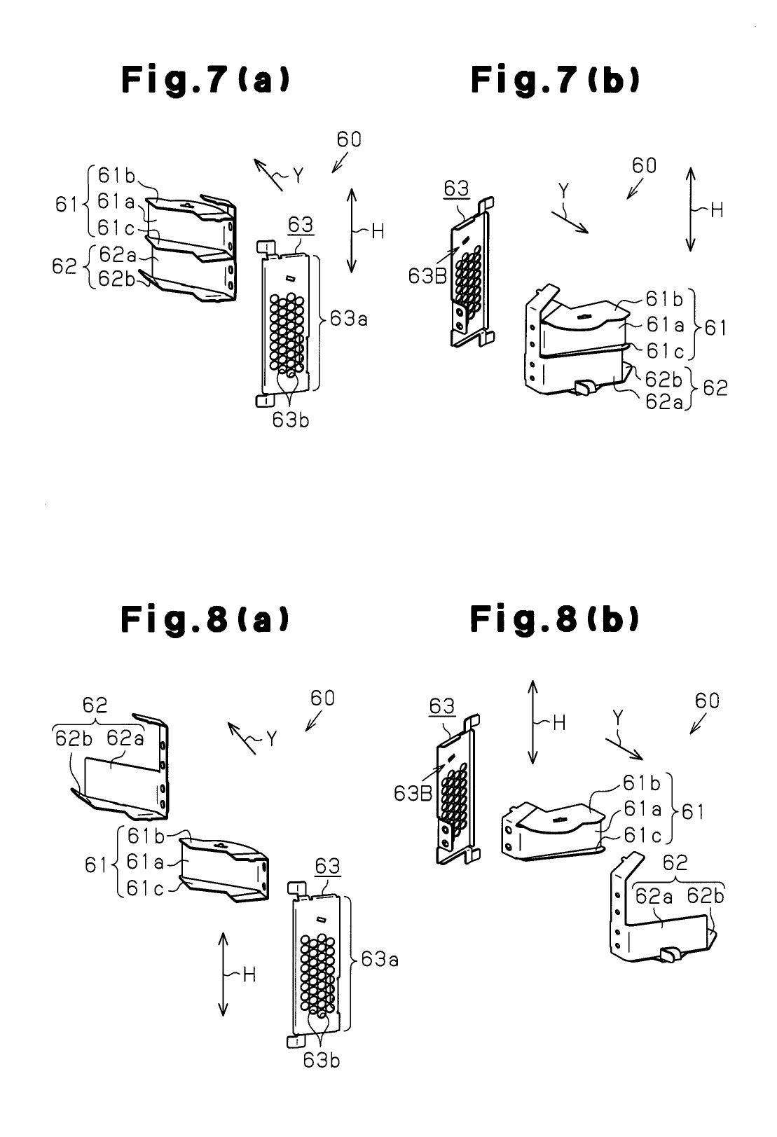

As shown in FIGS. 6 and 7, the plate portion 61a of the airflow redirection plate 61 and the plate portion 62a of the airflow redirection plate 62 are adjacent to each other. The side wall portion 61c of the airflow redirection plate 61 partitions the cooling airflow passage extending along the airflow redirection plate 61 from the cooling airflow passage extending along the airflow redirection plate 62. In the illustrated example, the plate portions 61a and 62a are flat and inclined plates.

The support 63 includes a flat portion 63a that is large enough to cover the entire ventilation hole 52a. A plurality of orifices 63b extend through part of the flat portion 63a. The airflow redirection plates 61 and 62 are spot-welded and fixed to the support 63.

The airflow redirection member 60 includes an open portion 64 and a closed portion 65. The open portion 64 is configured to allow the cooling airflow from the duct 40 to pass into the reflection chamber of the reflector 12. The closed portion 65 is configured to form stagnation of the cooling airflow in the duct 40.

Specifically, the flat portion 63a of the support 63 includes the open portion 64, which is defined by an array of the orifices 63b allowing passage of the cooling airflow, and the closed portion 65, which the cooling airflow does not pass through. As shown in FIG. 9, cooling airflows F1 and F2 passing through the open portion 64 flow into the reflection chamber of the reflector 12 (i.e., an interior space defined by a paraboloidal reflection surface 12b of the reflector 12).

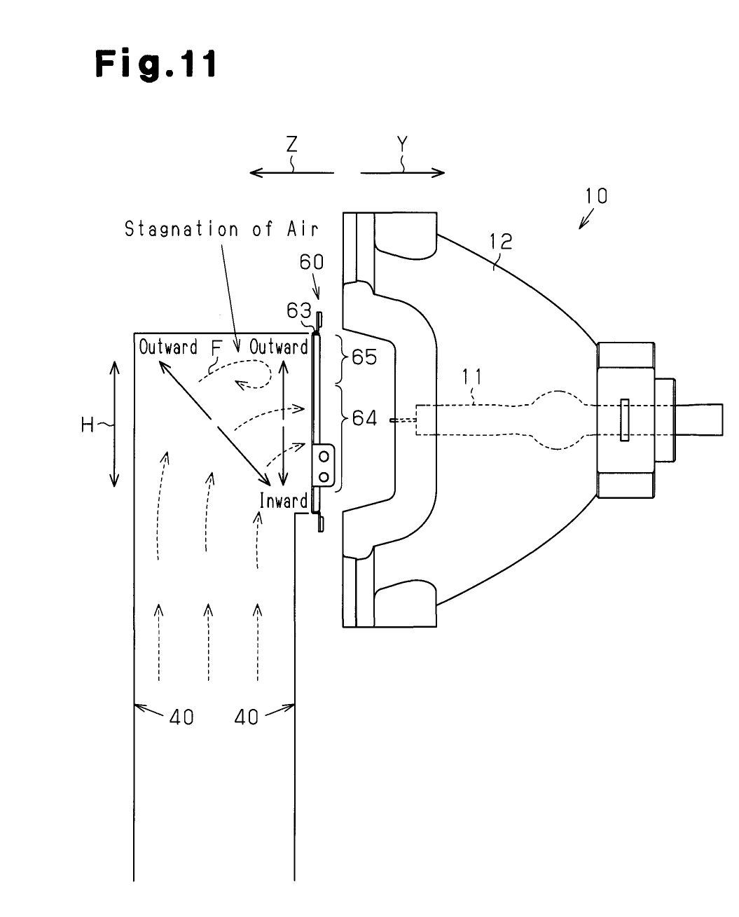

The closed portion 65 is part of the flat portion 63a and serves to stagnate a part of a cooling airflow F in the duct 40 and thereby form an air reservoir, or stagnation of the cooling airflow F in the duct 40. One example of the stagnation of the cooling airflow F is illustrated in FIGS. 10 and 11. As shown in FIGS. 10 and 11 in which the airflow redirection plate is omitted, the closed portion 65 is located at an outward side of a bent portion in the cooling airflow passage, and the open portion 64 is located inward from the closed portion 65 in the bent portion of the cooling airflow passage. The term “outward” refers to a direction extending away from a swirling center of the cooling airflow that is about to enter the reflection chamber of the reflector 12 at the bent portion of the cooling airflow passage on a cross-sectional plane taken along a direction parallel to the direction Z in which the lamp 10 emits light. The term “inward” refers to a direction extending toward the swirling center of the cooling airflow that is about to enter the reflection chamber of the reflector 12 at the bent portion of the cooling airflow passage on the cross-sectional plane taken along the direction parallel to the direction Z in which the lamp 10 emits light.

Referring to FIGS. 10 and 11, the airflow redirection member 60 may be adjacent to the bent portion of the duct 40. At the bent portion of the duct 40, the side at which the passage length of the cooling airflow is shorter is referred to as the inward side of the bent portion, and the side at which the passage length of the cooling airflow is longer is referred to as the outward side of the bent portion. The arrows formed by broken lines in FIG. 10 indicate the airflow passage length of the cooling airflow at the bent portion of the duct 40.

Due to the closed portion 65, in the bent portion of the cooling airflow passage at which a swirling flow component is produced, the cooling airflow at the relatively outward side of the bent portion does not immediately flow out of the duct 40 toward the light emitting tube 11 and stagnates in the duct 40. The closed portion 65 thus forms stagnation of the cooling airflow in the duct 40. The stagnation of the cooling airflow functions to adjust the direction of the airflow discharged from the open portion 64. Specifically, the cooling airflow at the relatively inward side of the bent portion in the cooling airflow passage produces a swirling flow component having a tendency of being deflected from the light emitting tube 11 due to the swirling inertia of the airflow. However, the stagnation of the cooling airflow produced in the duct 40 by the closed portion 65 weakens or eliminates the swirling inertia of the airflow. Therefore, the cooling airflow, which passes through the open portion 64 from the duct 40 and enters the reflection chamber of the reflector 12, flows towards the light emitting tube 11.

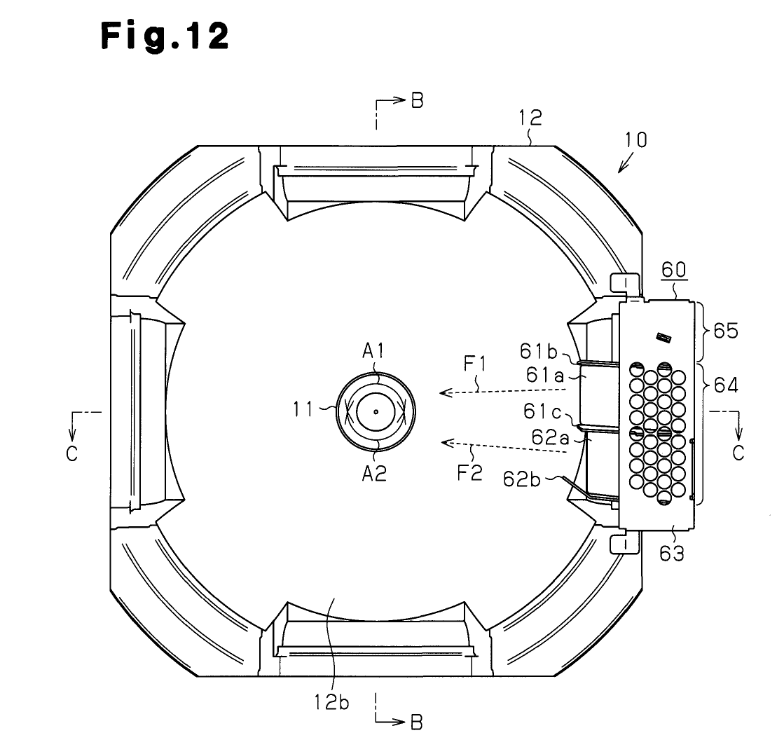

In the preferred embodiment, the airflow redirection member 60 includes the airflow redirection plates 61 and 62 serving as guide members for guiding the cooling airflow that passes through the open portion 64 and flows into the reflection chamber of the reflector 12 towards the light emitting tube 11. As shown in FIG. 12, a circumferential surface half A1 and a circumferential surface half A2 are defined on opposite sides of the light emitting tube 11. The airflow redirection plate 61 guides the cooling airflow F1 to the circumferential surface half A1, and the airflow redirection plate 62 guides the cooling airflow F2 to the other circumferential surface half A2. Thus, the airflow redirection plate 61 and the airflow redirection plate 62 evenly cool the entire circumference of the light emitting tube 11.

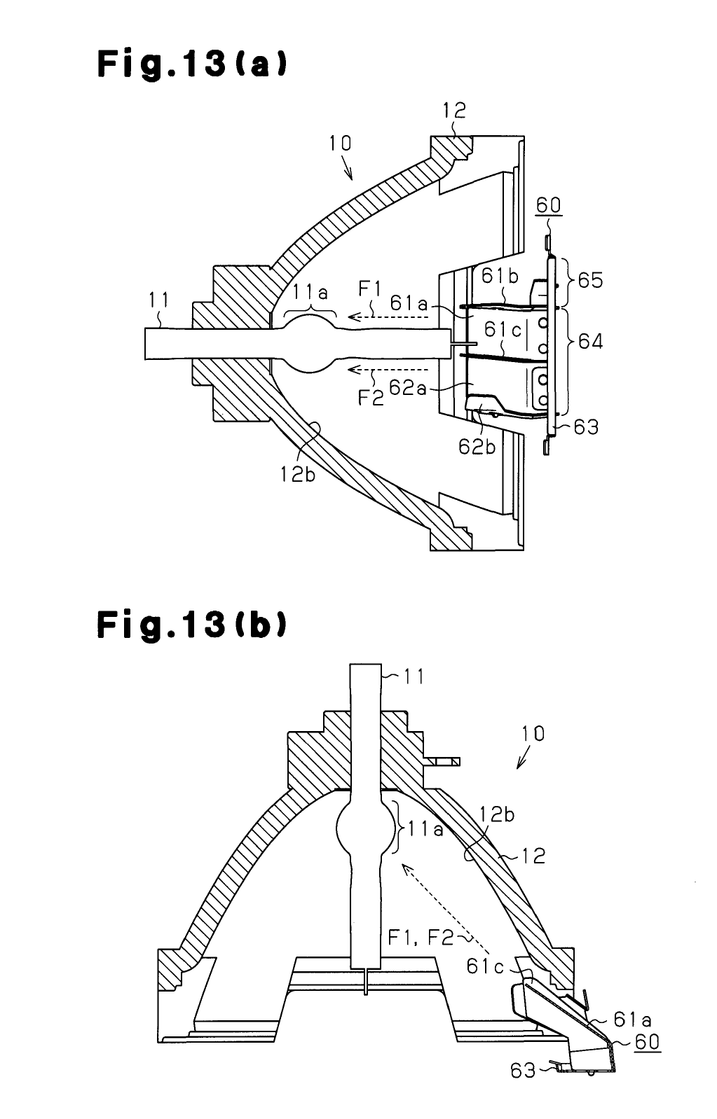

As shown in FIG. 13, the light emitting tube 11 includes a spherical portion 11a. The airflow redirection plates 61 and 62 guide the cooling airflows F1 and F2 so that the cooling airflows F1 and F2 flow straight toward the spherical portion 11a of the light emitting tube 11. Thus, the cooling airflows F1 and F2 directly strike the spherical portion 11a of the light emitting tube 11. The spherical portion 11a of the light emitting tube 11 is a light emitting portion that seals a luminous body. The light emitting tube 11 is cooled more effectively when arranging the airflow redirection plates 61 and 62 so that the cooling airflow directly strikes the spherical portion 11a compared to when the cooling airflow strikes the spherical portion 11a after traveling along the parabolic light reflection surface 12b of the reflector 12.

The LCD projector 1 of the preferred embodiment has the advantages described below.

(1) The cooling airflow passage includes the airflow redirection member 60, which adjusts the direction of the cooling airflow. The airflow redirection member 60 includes the open portion 64, which allows passage of the cooling airflow from the duct 40 into the reflection chamber of the reflector 12, and the closed portion 65, which forms stagnation of the cooling airflow in the duct 40. This stagnates the cooling airflow F that does not flow out of the duct 40 and towards the light emitting tube 11 in the duct 40. The stagnation of the cooling airflow in the duct 40 produced from the cooling airflow adjusts the direction of the cooling airflow that flows out of the duct 40 through the open portion 64, enters the reflection chamber of the reflector 12, and flows towards the light emitting tube 11. As a result, the direction of the cooling airflow is not deflected away from the light emitting tube 11 by the shape of the cooling airflow passage. This improves the degree of design freedom for the duct 40, which defines the cooling airflow passage. Further, the light emitting tube 11 is effectively cooled by the cooling airflow that flows into the reflection chamber of the reflector 12 towards the light emitting tube 11.

(2) The closed portion 65 is located at the outward side of the bent portion in the cooling airflow passage, and the open portion 64 is located inward from the closed portion 65 at the bent portion of the cooling airflow passage. This stagnates in the duct 40 the cooling airflow F at the outward side of the cooling airflow passage that does not flow out of the duct 40 and towards the light emitting tube 11.

(3) The open portion 64 is defined by an array of the orifices 63b extending through part of the airflow redirection member 60. Thus, even if the light emitting tube 11 were to break due to wear, the open portion 64 would prevent fragments of the broken light emitting tube 11 from entering the duct 40.

(4) The airflow redirection member 60 includes the airflow redirection plates 61 and 62 to guide the cooling airflow, which passes through the open portion 64 and enters the reflection chamber of the reflector 12, towards the light emitting tube 11. This ensures that the cooling airflows F1 and F2 strike the light emitting tube 11.

(5) The guide member that guides the cooling airflow towards the light emitting tube 11 includes the airflow redirection plates 61 and 62. The airflow redirection plate 61 guides the cooling airflow F1 to the circumferential surface half A1 of the light emitting tube 11 and the airflow redirection plate 62 guides the cooling airflow F2 to the other circumferential surface half A2 of the light emitting tube 11. Accordingly, the airflow redirection plate 61 and the airflow redirection plate 62 cooled the entire circumference of the light emitting tube 11. Thus, the upper side of the light emitting tube 11 is always properly cooled regardless of the arrangement of the LCD projector 1.

(6) The support 63, which supports the airflow redirection plates 61 and 62, includes the open portion 64 and the closed portion 65. Thus, the airflow redirection member 60 does not require additional components to form the open portion 64 and the closed portion 65.

It should be apparent to those skilled in the art that the present invention may be embodied in many other specific forms without departing from the spirit or scope of the invention. Particularly, it should be understood that the present invention may be embodied in the following forms.

In the preferred embodiment, the open portion 64 and the closed portion 65 are formed in the support 63. However, the support 63 may include only the open portion 64, and the closed portion 65 may be formed in the airflow redirection member 60 by covering part of the open portion 64 with another component. Alternatively, the open portion 64 and the closed portion 65 may be formed by components other than the support 63.

In each of the embodiments described above, the guide member guiding the cooling airflow that passes through the open portion 64 and flows into the reflection chamber of the reflector 12 towards the light emitting tube 11 is formed by the airflow redirection plates 61 and 62. When necessary, the shapes of the airflow redirection plates 61 and 62 may be changed. Further, a guide member other than the airflow redirection plates 61 and 62 may be used.

In each of the embodiments described above, the open portion 64 is defined by an array of the orifices 63b extending through part of the airflow redirection member 60. However, the present invention is not limited in such a manner. For example, the open portion 64 may be defined by a single, large rectangular hole.

In each of the embodiments described above, the closed portion 65 is located at the outward side of the bent portion in the cooling airflow passage and the open portion 64 is located inward from the closed portion 65 at the bent portion of the cooling airflow passage. However, the locations of the open portion 64 and the closed portion 65 may be changed when necessary as long as stagnation of the cooling airflow can be formed in the duct 40 without flowing out of the duct 40 towards the light emitting tube 11.

The cooling airflow passage of the illustrated embodiment has a L-shaped bent portion. The bent portion of the cooling airflow passage may be V-shaped, U-shaped, or a shape combining any of these shapes.

In each of the embodiments described above, the present invention is applied to the LCD projector 1. However, the present invention may be applied to any type of projector.

The present examples and embodiments are to be considered as illustrative and not restrictive, and the invention is not to be limited to the details given herein, but may be modified within the scope and equivalence of the appended claims.

What is claimed is:

1. A video projector comprising:
an light emitting tube which emits light to display an image;
a reflector encompassing the light emitting tube and defining a reflection chamber;
a cooling fan which generates a cooling airflow for cooling the light emitting tube;
a duct defining a cooling airflow passage, which includes a bent portion, arranged between the cooling fan and the light emitting tube; and
an airflow redirection member which adjusts the direction of the cooling airflow in the cooling airflow passage;
wherein the airflow redirection member includes an open portion, which allows passage of the cooling airflow from the duct into the reflection chamber of the reflector, and a closed portion, which forms stagnation of the cooling airflow in the duct.

2. The video projector according to claim 1, wherein the closed portion is associated with a relatively outward side of the bent portion in the cooling airflow passage, and the open portion is associated with a relatively inward side of the bent portion in the cooling airflow passage.

3. The video projector according to claim 1, wherein the open portion defined by an array of orifices extending through part of the airflow redirection member.

4. The video projector according to claim 1, wherein the airflow redirection member includes a guide member which guides the cooling airflow that passes through the open portion and flows into the reflection chamber of the reflector towards the light emitting tube.

5. The video projector according to claim 4, wherein the guide member includes a first airflow redirection plate and a second airflow redirection plate, in which the first airflow redirection plate guides part of the cooling airflow towards one of two circumferential surface halves of the light emitting tube, and the second airflow redirection plate guides a further part of the cooling airflow towards the other one of the circumferential surface halves of the light emitting tube.

6. The video projector according to claim 4, wherein the airflow redirection member includes a support member which supports the guide member, in which the open portion and the closed portion are arranged on the support member.

7. The video projector according to claim 5, wherein:
the light emitting tube includes a spherical light emitting portion; and
the first and second airflow redirection plates each guide the cooling airflow straight toward the spherical light emitting portion.

8. The video projector according to claim 1, wherein the airflow redirection member is arranged adjacent to the bent portion of the cooling airflow passage.

9. The video projector according to claim 8, wherein the airflow redirection member is arranged diagonally in front of the light emitting tube.
